(19) United States
(12) Patent Application Publication
(10) Pub. No.: US 2009/0255745 A1
(43) Pub. Date: Oct. 15, 2009

(54) MOTORIZED SNOWBOARD

(75) Inventors: GERALD A. KUKOWSKI, BADGER, MN (US); BRAD TEUBNER, ROSEAU, MN (US)

Correspondence Address: BAKER & DANIELS LLP, 300 NORTH MERIDIAN STREET, SUITE 2700, INDIANAPOLIS, IN, 46204, US

(73) Assignee: POLARIS INDUSTRIES INC., MEDINA, MN (US)

(21) Appl. No.: 12/019,203

(22) Filed: Jan. 24, 2008

Related U.S. Application Data
(60) Provisional application No. 60/897,130, filed on Jan. 24, 2007.

(51) Int. Cl. B62M 27/02

(52) U.S. Cl. 180/190

(57) ABSTRACT

A motorized snowboard is disclosed having a chassis including a rider support platform, a motor supported by the chassis, and an endless track powered by the motor.

### RELATED APPLICATION

This application claims priority to U.S. Provisional Patent Application Ser. No. 60/897,130, to Kukowski et al., filed Jan. 24, 2007, titled “Motorized Snowboard,” the entire disclosure of which is expressly incorporated by reference herein.

### FIELD OF THE INVENTION

The present invention relates to snowboards. More particularly, the present invention relates to motorized snowboards.

### BACKGROUND OF THE INVENTION

According to one aspect of the present disclosure, a motorized snowboard is provided including a chassis having a rider-support platform positioned to support the feet of a rider and extending across the longitudinal plane of the motorized snowboard; a motor supported by the chassis in a forward position; and an endless track positioned to contact the ground. The endless track is coupled to the chassis and powered by the motor to propel the motorized snowboard over the ground. The snowboard further includes a motor control positioned behind the longitudinal midpoint of the motorized snowboard and configured to control the motor.

According to another aspect of the present disclosure, a motorized snowboard is provided including a chassis having a rider-support platform positioned to support the feet of a rider and extending across the longitudinal plane of the motorized snowboard. The rider-support platform includes a binding configured to hold a rider's foot relative to the chassis. The longitudinal position of the binding being adjustable. The snowboard further includes a motor supported by the chassis and an endless track positioned to contact the ground. The endless track is coupled to the chassis and powered by the motor to propel the motorized snowboard over the ground.

According to another aspect of the present disclosure, a motorized snowboard is provided including a chassis including a rider-support platform positioned to support the feet of a rider and extending across the longitudinal plane of the motorized snowboard; a motor supported by the chassis; and an endless track positioned to contact the ground. The endless track is coupled to the chassis and powered by the motor to propel the motorized snowboard over the ground. A ground-engaging portion of the endless track having a forward portion, a mid portion, and a rear portion. The elevation of the mid portion being lower than at least one of the front and rear portions.

The above mentioned and other features of this invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 is a perspective view of a motorized snowboard according to the present disclosure showing the snowboard including a front ski, a cowl positioned over the front ski, a handle extending from the cowl, a platform extending rearward from the cowl, and an endless track positioned under the platform;

FIG. 2 is a view similar to FIG. 1 showing the cowl removed from the remainder of the snowboard showing a motor and a transmission positioned over the ski;

FIG. 3 is a front view of the snowboard of FIG. 1;

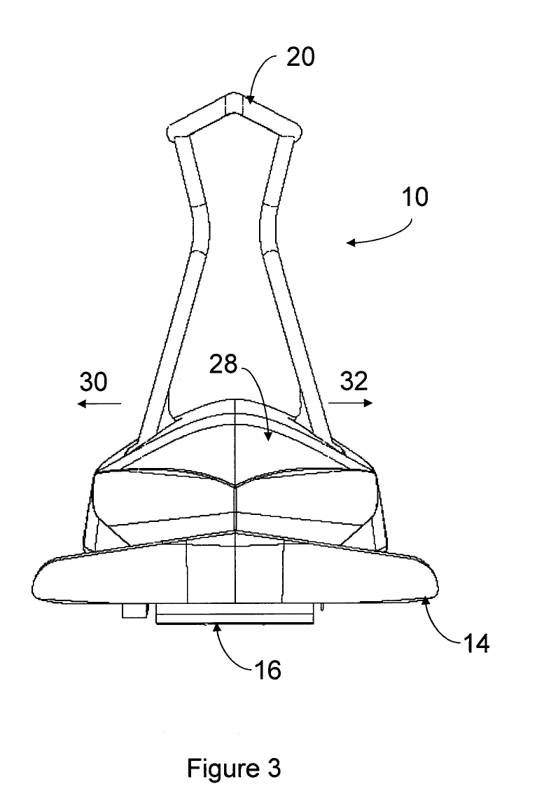

FIG. 4a is a rear view of the snowboard of FIG. 1;

FIG. 4b is a view similar to FIG. 4a showing an alternative placement of fluid storage areas between the platform and the endless track;

FIG. 5a is a side elevation view of the snowboard of FIG. 1;

FIG. 5b is an opposite side elevation view of the snowboard of FIG. 1;

FIG. 6 is a top plan view of the snowboard of FIG. 1;

FIG. 7 is a bottom view of the snowboard of FIG. 1;

FIG. 8 is a perspective view of the snowboard of FIG. 1 showing a rear portion of the snowboard cut away;

FIG. 9 is a perspective view of the snowboard of FIG. 1 showing a left portion of the snowboard cut away;

FIG. 10 is a side-elevation view of the snowboard of FIG. 1 showing the left portion of the snowboard cut away;

FIG. 11 is a cross-sectional view of a controller for use with the snowboard of FIG. 1.

Corresponding reference characters indicate corresponding parts throughout the several views. Unless otherwise indicated, the drawings are to scale so that the components are proportional to one another.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings.

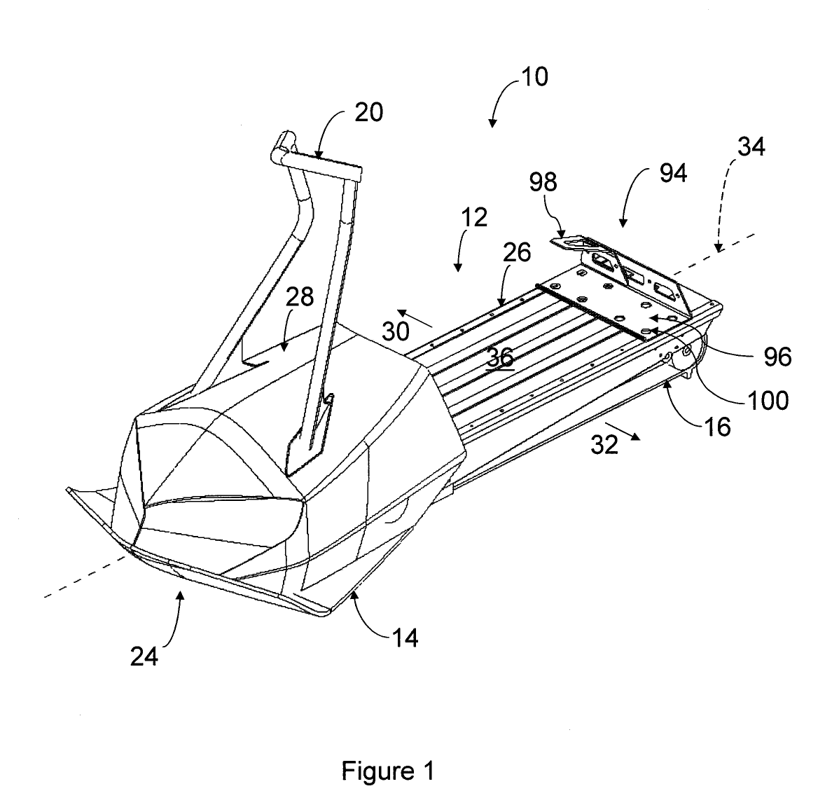

As shown in FIG. 1, a snowboard 10 is provided that includes a frame or chassis 12, a front ski 14 coupled to chassis 12, an endless track 16 coupled to chassis 12, a motor 18 supported by chassis 12 that powers rotation of endless track 16, a handle 20, and a remote, hand-held control 22. Chassis 12 includes a forward portion 24 and a rear portion or platform 26 coupled to forward portion 24. Forward portion 24 supports motor 18 and ski 14 is coupled to an underside of forward portion 24 of chassis 12. Snowboard 10 also includes a cowl 28 that covers motor 18.

During use, a rider stands on platform 26 with their feet extending in either direction 30 or direction 32 that are substantially perpendicular to a longitudinal axis 34 of snowboard 10 as shown in FIG. 1. The rider grasps handle 20 for support and to assist in steering snowboard 10 as described below. The riders controls the operation of motor 18 with remote control 22 to control the throttle of motor 18 and to stop motor 18. While riding, the rider grasps handle 20 with one hand and holds remote control 22 with the other hand.

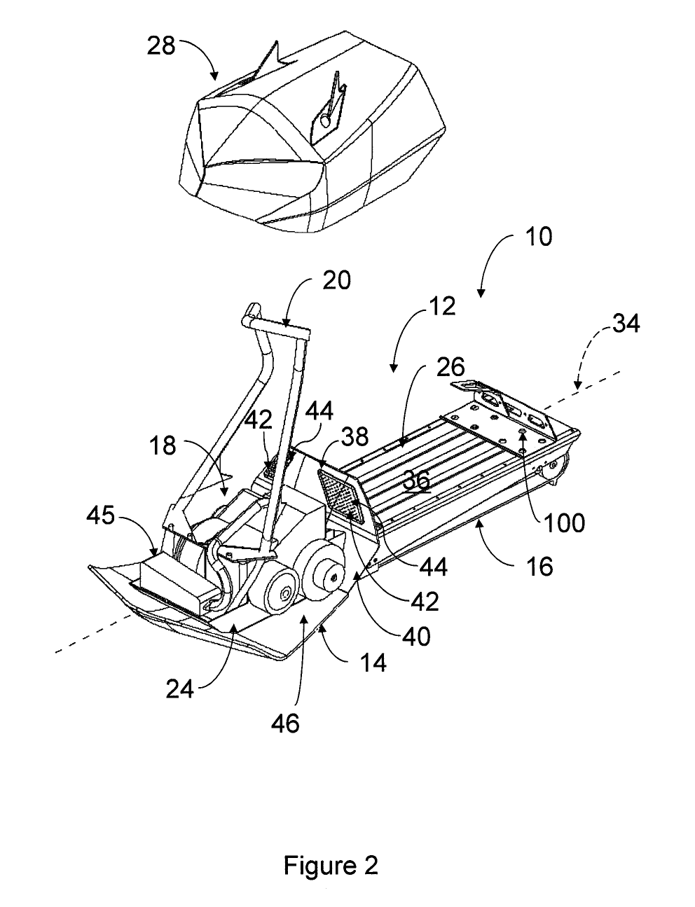

As shown in FIG. 2, motor 18 is positioned in front of platform 26 and portions of motor 18 are positioned below an upper surface 36 of platform 26 and portions of motor 18 are positioned above upper surface 36. As also shown in FIG. 2, motor 18 is positioned directly above ski 14. According to the presently preferred embodiment, motor 18 is an air cooled, 4-cycle, overhead cam, internal combustion engine. According to other embodiments, other motors may be provided, such as 2-cycle engines, turbo-charged engines, liquid-cooled engines, DC or electric motors, or other motors known to those of ordinary skill in the art.

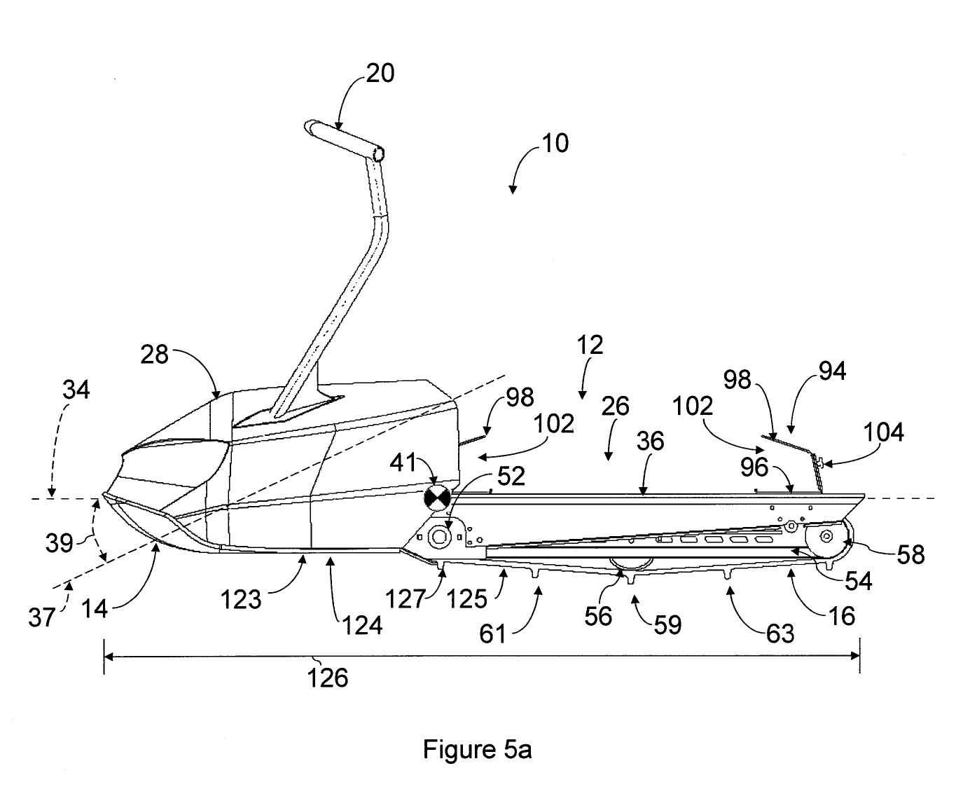

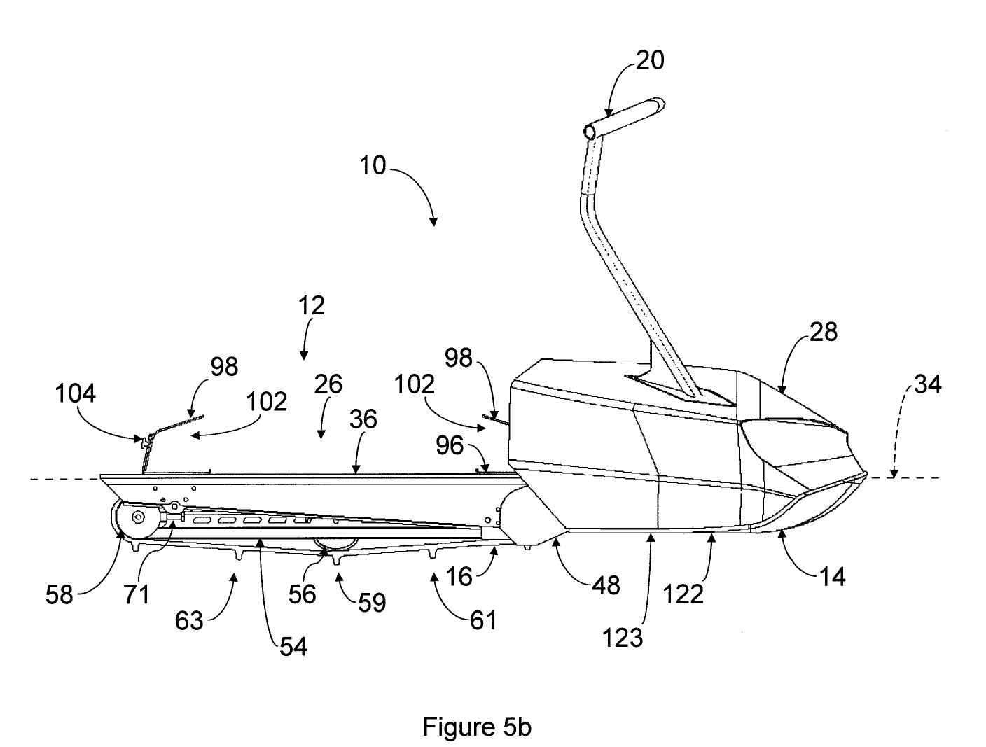

As indicated in FIG. 5a, motor 18 is oriented in a rearward direction so that an axis of reciprocation or centerline 37 of a piston (not shown) of motor 18 and longitudinal axis 34 of snowboard 10 cooperate to define an angle 39 of about 25°. According to other embodiments, angle 39 could be other angles, such as any angle between about 15° to about 65°, or any other angle including orientations in vertical, forward, or sideways directions or any combinations of these directions. Because of this orientation, a front end of snowboard 10′ has a lower profile and lower, more rearward center of gravity 41 than if centerline 37 were more upright or vertical. According to one embodiment, center of gravity 41 is positioned at about the height of upper surface 36 of platform 26 near the lower back portion of cowl 28 as shown in FIG. 5a and along a centerline of snowboard 10. According to other embodiments, the center of gravity is positioned at other locations within a few inches of the position shown in FIG. 5a or in other locations.

Cowl 28, ski 14, and a wall 38, cooperate to define a motor or an engine compartment 40 as shown in FIG. 2. Wall 38 includes a pair of air-intakes 42 permitting fresh air to enter engine compartment 40. Screens 44 are provided to cover intakes 42 and permit air to flow therein and to block objects to pass therethrough. A muffler 45 is positioned in front of motor 18 and connects to motor 18 to transfer exhaust gases out of the engine compartment through an exhaust port (not shown) provided in location 43 to exhaust engine gases.

Snowboard 10 further includes a transmission 46 that transfers power from motor 18 to endless track 16. According the present disclosure, transmission 46 is a CVT (continuously variable transmission). According to other embodiments, transmission 46 may be any other type of transmission, such as a centrifugal chain clutch.

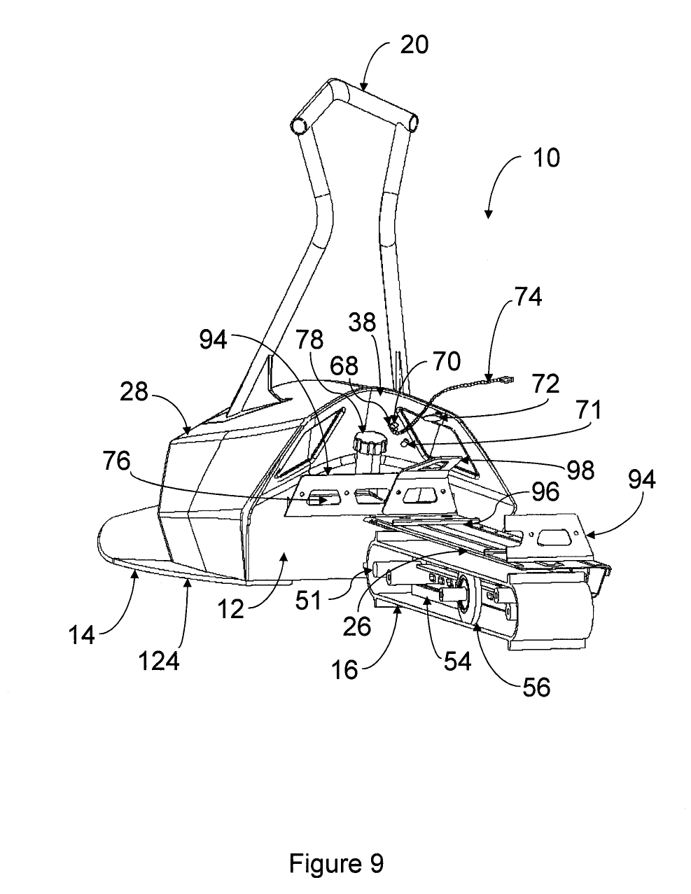

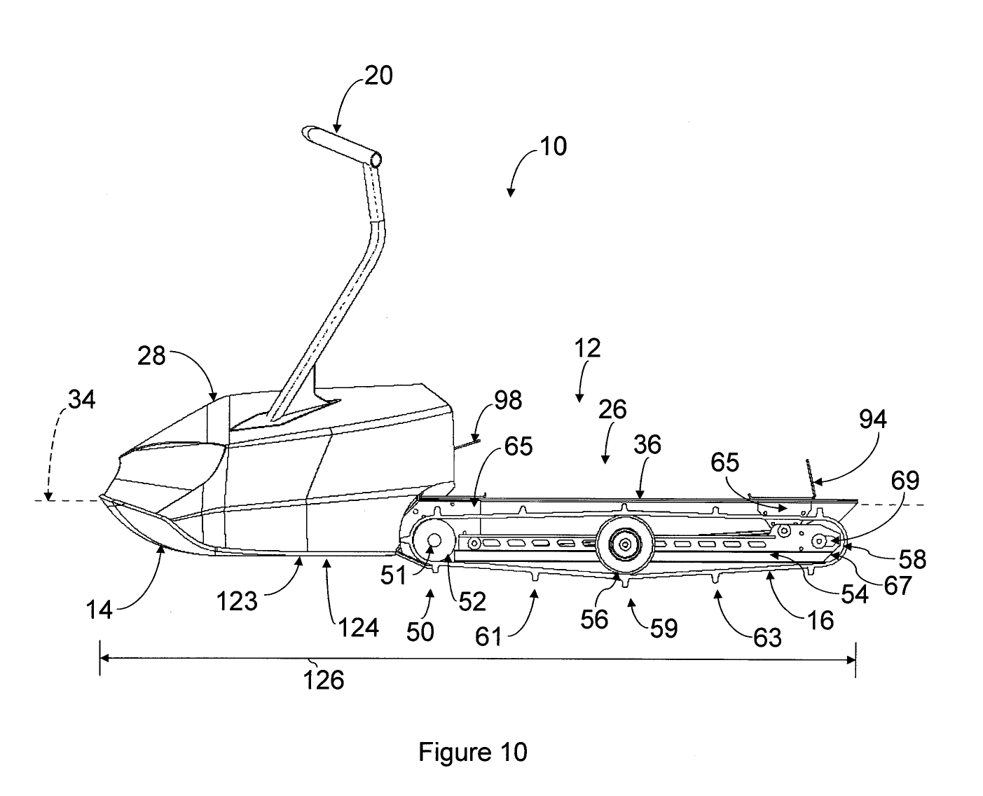

A transfer shaft (not shown) extends under motor 18 from transmission 46 to a power transfer mechanism 48, which may be a chain, belt, gear set, or other power transfer mechanism as shown in FIG. 5b. Mechanism 48 transfers power from transmission 46 to a drive sprocket assembly 50, shown in FIGS. 9 and 10. Drive sprocket assembly 50 transfers power to endless track 16.

Drive sprocket assembly 50 includes a drive shaft 51 rotationally supported on platform 26 that receives power from power transfer mechanism 48 and rotates a drive sprocket 52. Drive sprocket 52 engages endless track 16 and causes it to rotate to propel snowboard 10 over the ground. It is understood that track 16 may be formed in configurations other than those described herein and shown in the figures.

As shown in FIG. 5a, a pair of suspension rails 54 are coupled to platform 26 and a plurality of bogie wheels 56 are coupled to rails 54 to allow endless track 16 to slide under rails 54. A pair of idler wheels 58 are also coupled to rails 54 to turn track 16 back toward drive sprocket 52.

As shown in FIGS. 5a, 5b, and 10, bogie wheels 56 have a diameter greater than the diameter of sprocket 52 and idler wheels 58 so that bogie wheels 56 extend down further than sprocket 52 and idler wheels 58 and creates a low point 59 for endless track 16. According to an alternative embodiment, this low point 59 is created by other means, such as providing bogie wheels with lower mounting positions than sprocket 52 and idler wheels 58 or providing rails 54 with a downward bow.

According to the present disclosure, the bottom of bogie wheels 56 are 0.75 inches lower than the bottoms of sprocket 52 and idler wheels 58. Similarly, the bottom of bogie wheels 56 are 0.75 inches lower than the bottom surface of rails 54. By providing low point 59, the “wheelbase” of snowboard 10 is shorter than if no single low point was provided. By having a shorter wheelbase, snowboard 10 is easier to turn than with a longer wheelbase.

Low point 59 also acts as a fulcrum for distributing the driving force of endless track 16. If enough of a rider's weight is distributed closer to the front of snowboard 10, a front portion 61 of endless track 16 will have more driving contact with the ground than a rear portion 63 of endless track 16. If the rider shifts sufficient weight behind low point 59, rear portion 63 will have more driving contact with the ground. As shown in FIG. 10, bogie wheels 56 are approximately centered between sprocket 52 and idler wheels 58. According to another embodiments, bogie wheels 56 are shifted forward or backward of this location by approximately 1, 2, 3, or 4 inches.

As shown in FIG. 10, rails 54 are coupled to platform 26 by brackets 65. According to alternative embodiments of the present disclosure, a suspension is provided between rails 54 and chassis 12. For example, according to one embodiment, rear end 67 of rails 54 floats relative to platform 26 and a suspension component, such as a spring loaded shock absorber extends between a portion of rails 54, such as rear end 67, and platform 26. According to another embodiment, bogie wheels 56 are allowed to float relative to rails 54 and are provided with suspension components so that bogie wheels 56 can move upwardly relative to platform 26 against a spring force. The tension in track 16 can be adjusted by moving idle wheels 58 forward or backward in slot 69. An adjustment bolt 71 (see FIG. 5b) is turned to force wheels 58 in either direction.

Motor 18 rotates endless track 16 to propel snowboard 10 and hand-held control 22 controls the operation of motor 18. Control 22 is tethered to motor 18 by a cord 60 through which control signals are sent from control 22 to motor 18. Cord 60 may include a sheath and cable, electrical lines, or any other means for sending a control signal from control 22 to motor 18. By having control 22 remote from handle 20 a rider can have one hand in front of their torso that grasps handle 20 and a second hand behind their torso that grasps control 22. According to one embodiment, cord 60 is about six feet long. According to other embodiments, cord 60 may be other lengths, such as four, five, seven, eight, or nine feet. Cord 60 may be clipped or otherwise fastened to an upper portion of handle 20 so that cord 60 extends up from cowl 28 to handle 20. According to another embodiment, cord 60 extends through or along platform 26 and extends up near the back end of platform 26. According to other embodiments, other remote controls may be provided, such as a wireless remote control having a wireless transmitter in the hand held portion and a receiver in communication with motor 18.

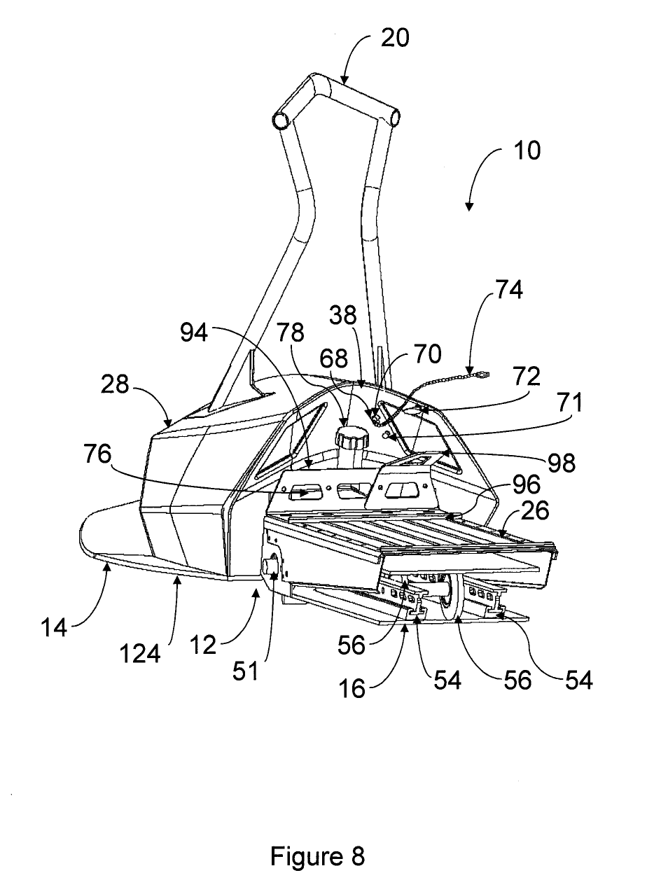

Control 22 includes an on/off switch 62, a trigger throttle 64, and a throttle trigger interlock 66. To start motor 18, a rider inserts a key 68 (shown in FIG. 8) into ignition 70 mounted on wall 38, moves switch 62 to the on position, and pulls on a pull cord 72 that extends through wall 38 to motor 18. Motor 18 also includes a choke 71 mounted on wall 38 that may be adjusted to facilitate starting. To control the speed of motor 18, the rider squeezes trigger throttle 64 and throttle trigger interlock 66. If throttle trigger interlock 66 is not squeezed, trigger throttle 64 will not throttle motor 18.

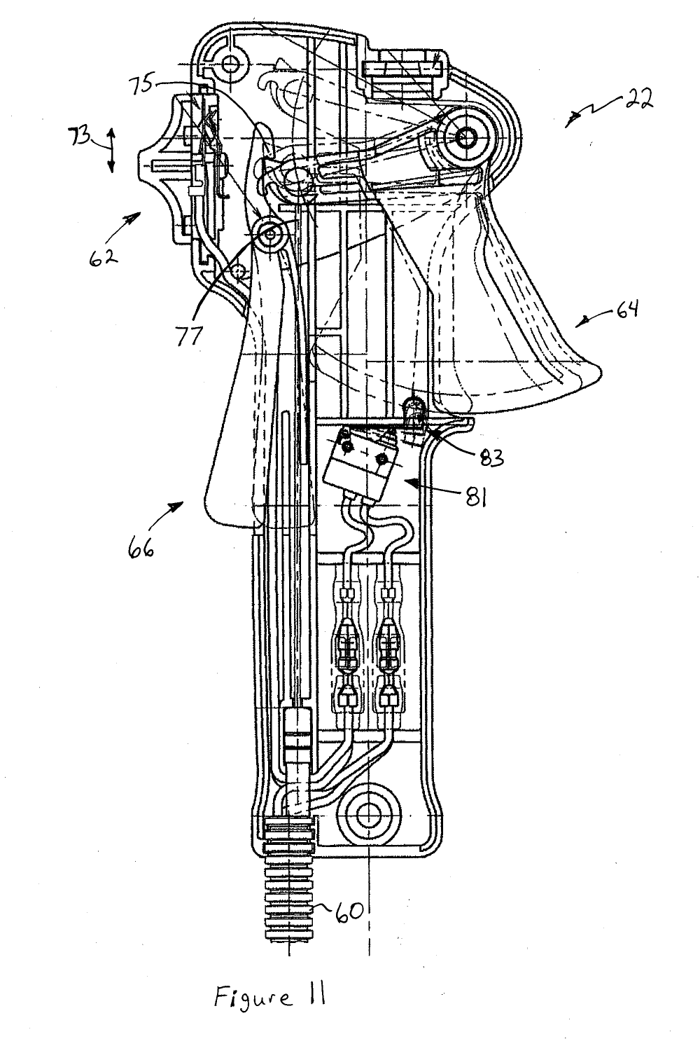

Additional detail of control 22 is provided in FIG. 11. On/off switch 62 moves between open and closed positions in direction 73. When in the closed position, switch 62 communicates an input to motor 18. Without this input, motor 18 will not start or continue running. According to one embodiment, this input is a connection to electrical ground. Without the connection to ground, motor 18 will not start or continue running. According to another embodiment, this input is a connection to a positive (or other) voltage. Without the connection to positive voltage, motor 18 will not start or continue running.

Throttle trigger interlock 66 includes a latch 75 that blocks pivoting movement of trigger throttle 64 when interlock 66 is not depressed. When interlock 66 is depressed, latch 75 no longer blocks movement of trigger throttle 64. Rotational movement of trigger throttle 64 (shown in phantom) pulls throttle cable 77 to provide a throttle input to motor 18.

Control 22 includes a throttle switch 81 that is positioned to detect movement of trigger throttle 64. Control 22 includes a roller 83 positioned adjacent to trigger throttle 64 that opens and closes switch 81 based on rotation of trigger throttle 64. When closed, throttle switch 81 communicates an input to motor 18. Without this input, the speed of motor 18 is limited. According to one embodiment, the speed of motor 18 is limited to idle speed without this input. According to another embodiment, the speed of motor 18 is limited to between idle speed and a clutch engagement speed, which is above idle speed. According to one embodiment, this input is a connection to electrical ground. Without the connection to ground, the motor speed will not go above idle speed or, alternatively, the clutch engagement speed. According to another embodiment, this input is a connection to a positive (or other) voltage.

If control 22 is detached from snowboard 10, any input from on/off switch 62 and throttle switch 81 will be lost. Because the input from on/off switch 62 is lost, motor 18 will stop running. Further, because the input from throttle switch 82 is lost, motor 18 will not throttle past idle speed (or the clutch engagement speed), if motor 18 is still running.

Key 68 is attached to the rider by a tether 74. If the rider leaves snowboard 10, tether 74 will pull key 68 from ignition 70 and motor 18 will stop. Similarly, if on/off switch 62 is toggled to the off position, motor will stop. If trigger throttle 64 is released, motor 18 will slow down to an idle condition, but remain running. In some embodiments, control 22 may not include a trigger interlock and operation of the throttle will be controlled solely by trigger throttle 64.

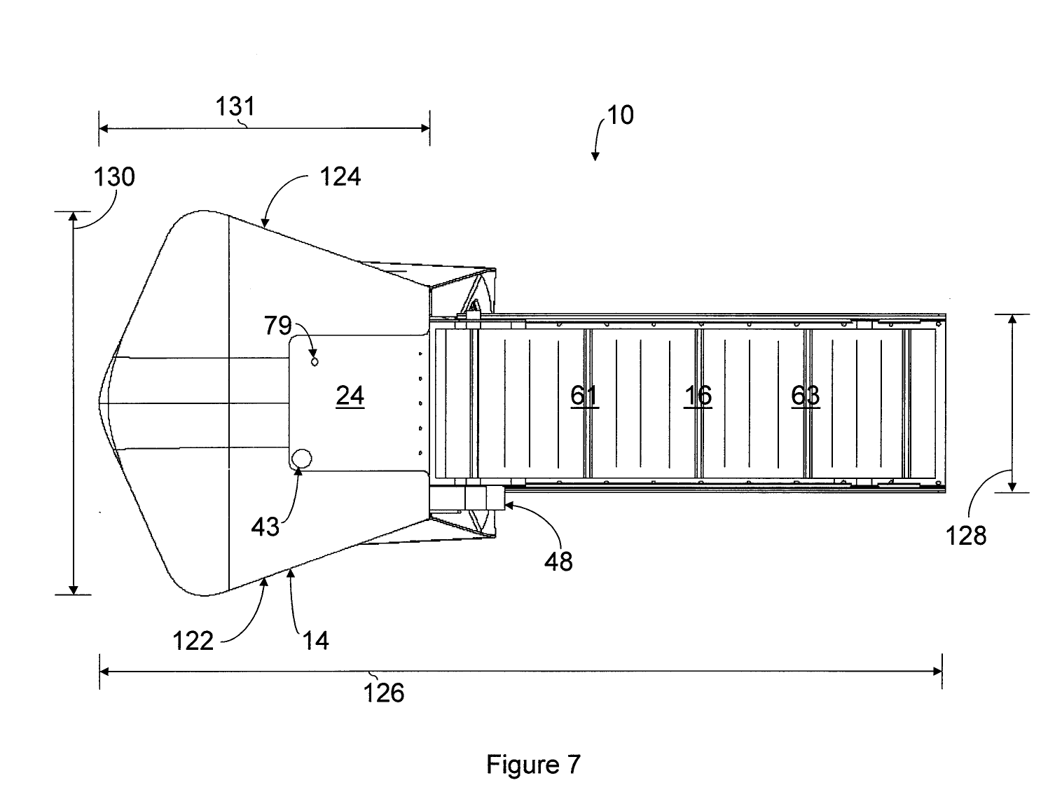

As mentioned above, motor 18 is preferably an air-cooled, internal combustion engine. As shown in FIG. 8, a fuel tank 76 is positioned below a filler-neck 78 located behind wall 38. An oil changing plug (not shown) is provided in location 79 shown in FIG. 7 to permit draining of oil from motor 18. According to one embodiment, an exhaust port (not shown) is also provided on the bottom of snowboard 10 in location 43 to permit the exhaust to be vented out the bottom of snowboard 10.

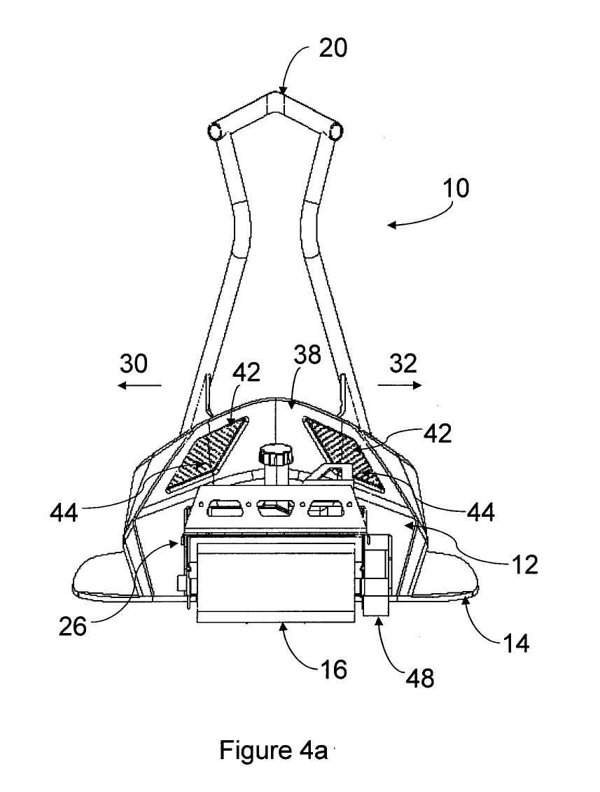

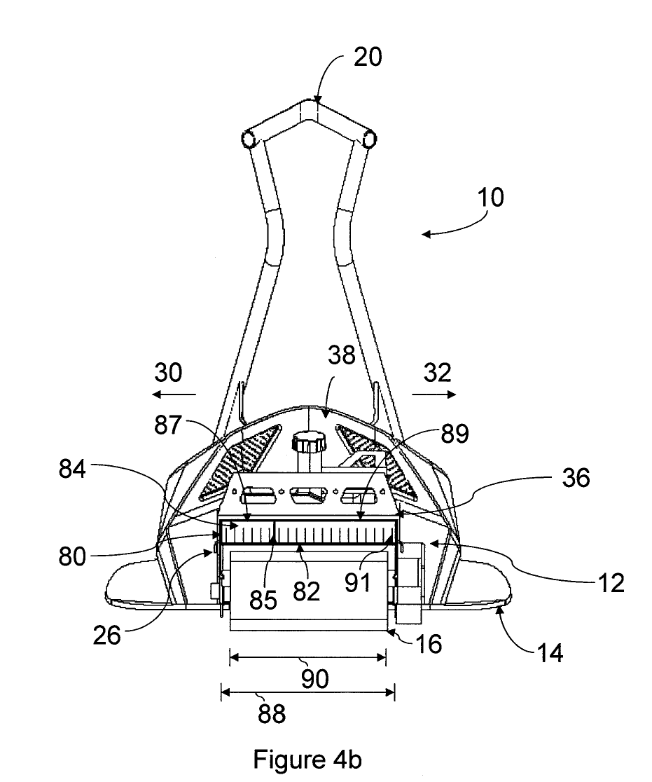

According to another embodiment, fuel and coolant for a fluid-cooled version of motor 18 are stored within platform 26 as shown in FIG. 4b. Platform 26 includes a U-shaped outer panel 80 and an inner panel 82 that cooperates with outer panel 80 to define a fluid-receiving space 84. This space 84 extends substantially the length of platform 26 so that at least portions of space 84 are positioned between upper surface 36 of platform 26 and endless track 16. Space 84 also extends substantially the entire width of platform 26 so that space 84 has a width 88 that is greater than or equal to width 90 of track 16.

According to one embodiment, a fuel bladder (not shown) and a coolant bladder (not shown) are positioned in space 84 and provide fuel and coolant to motor 18. According to another embodiment, a divider 85 is provided that divides space 84 into two compartments 87, 89. The ends of each compartment 87, 89 are closed and sealed so they are fluid tight to store either fuel or coolant. Appropriate hoses (not shown) extend between platform 26 and motor 18 to permit the flow of fuel and coolant between platform 26 and motor 18. To reduce sloshing of fluid within compartments 87, 89, longitudinally extending, perforated baffles 91 may be placed within compartments 87, 89. According to an alternative embodiment of the present disclosure, platform 26 is extruded an defines compartments 87, 89. If the motor coolant is warm enough, waste heat from the coolant stored in space 84 will pass through platform 26 and melt snow or ice on upper surface 36 of platform 26.

As shown in FIGS. 1 and 8, platform 26 further includes a pair of bindings 94 that are coupled to U-shaped panel 80 of platform 26. Each binding 94 includes a base 96 and an upper bracket or clip 98. Base 96 includes a plurality of apertures 100 having raised edges. The raised edges provide additional traction and permit snow and ice to be scraped from the bottom of the rider's boot. The longitudinal positions of bindings 94 may also be adjusted by uncoupling, moving, and re-coupling bindings 94 to panel 80.

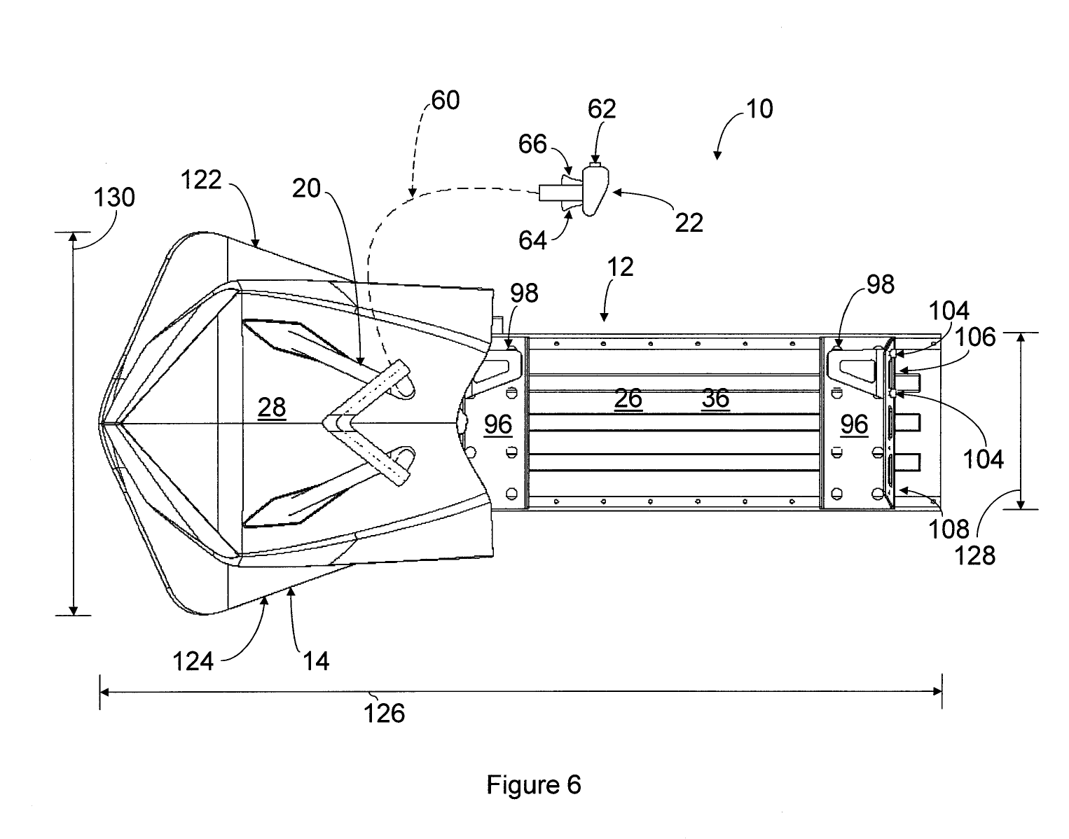

Panel 80, base 96, and upper clip 98 cooperate to define boot-receiving spaces 102 on platform 26 as shown in FIG. 5a. Boot-receiving spaces 102 are adjustable by move the position of clips 98 relative to respective bases 96. Clips 98 are coupled to respective bases 96 by knobs 104 and may include vertically oriented slots (not shown). To adjust the height of spaces 102, knobs 104 are loosened so they slide in the slots. Once repositioned, knobs 104 are tightened to fix the height of each respective space 102. Additionally as seen in FIG. 6, each clip 98 can be moved from the right or left side of base 96 to the other side of base 96. A first pair of apertures or slots are provided on a right side 106 of each base 96 and a second pair of apertures or slots are provided on a left side 108 of each base 96. Knobs 104 are fully loosened from one pair of apertures/slots to permit removal of the respective clip 98. Once removed, knobs 104 are positioned in the other pair of apertures/slots (right or left) and tightened.

A rider steers snowboard 10 by changing the orientation of snowboard 10 relative to the ground. A snowboard rider changes the amount of force applied to platform 26 at their heals or toes so that more of a right edge 122 or left edge 124 of snowboard 10 engages the ground, much like turning on snow skis.

As shown in FIG. 5a, a bottom surface 123 of ski 14 is elevated above a bottom surface 125 of endless track 16. Just below sprocket 52, bottom surface 123 is elevated about 1½ inches above the bottom of lug 127 of endless track 16. As shown in FIG. 6, snowboard 10 has an overall 126 of about 57¾ inches. Platform 26 has a width 128 of about 12 inches and upper surface 36 is about 5 inches above the ground. As shown in FIG. 7, ski 14 has a maximum width 130 of about 25¾ inches and a maximum length 131 of about 22¼ inches.

Additional embodiments of the present disclosure are provided in Appendix A and Appendix B of U.S. Provisional Patent Application Ser. No. 60/897,130, the entire disclosure of which is expressly incorporated by reference herein.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A motorized snowboard including
a chassis including a rider-support platform positioned to support the feet of a rider and extending across the longitudinal plane of the motorized snowboard,
a motor supported by the chassis in a forward position,
an endless track positioned to contact the ground, the endless track being coupled to the chassis and powered by the motor to propel the motorized snowboard over the ground, and
a motor control positioned behind the longitudinal midpoint of the motorized snowboard and configured to control the motor.

2. The motorized snowboard of claim 1, wherein the motor control includes a hand-held control and a tether coupling the hand-held control to the motor.

3. The motorized snowboard of claim 1, wherein the vertical, horizontal, and lateral positions of the motor control are adjustable relative to the chassis.

4. The motorized snowboard of claim 1, further comprising a vertically extending handle having a height greater than the motor, wherein at least a substantial portion of the rider-support platform is longitudinally positioned between the motor control and the handle.

5. The motorized snowboard of claim 1, wherein the motor control includes a throttle trigger and a throttle switch, the throttle trigger provides variable input to the motor to control the operating speed of the motor, the operating speed of the motor is limited to a predetermined speed until a control input is provided to the motor, the throttle switch detects the position of the throttle trigger and provides the control input to the motor when the throttle trigger reaches a predetermined position.

6. The motorized snowboard of claim 1, further comprising a fixed ski defining the widest portion of the motorized snowboard.

7. The motorized snowboard of claim 1, wherein the motor control is positioned at least four feet from the motor.

8. A motorized snowboard including
a chassis including a rider-support platform positioned to support the feet of a rider and extending across the longitudinal plane of the motorized snowboard, the rider-support platform including a binding configured to hold a rider's foot relative to the chassis, the longitudinal position of the binding being adjustable,
a motor supported by the chassis, and
an endless track positioned to contact the ground, the endless track being coupled to the chassis and powered by the motor to propel the motorized snowboard over the ground.

9. The motorized snowboard of claim 8, wherein the rider-support platform includes a pair of bindings, a first of the pair of bindings being positioned adjacent a forward portion of the rider-support platform and a second of the pair of bindings being positioned adjacent a rearward portion of the rider-support platform, the longitudinal position of at least one of the first and second bindings being adjustable.

10. The motorized snowboard of claim 9, wherein each binding includes a clip cooperating to define a boot-receiving space having a side opening toward the other binding.

11. The motorized snowboard of claim 9, wherein the rider-support platform has a substantially uniform width.

12. The motorized snowboard of claim 11, wherein the binding extends substantially the width of the rider-support platform.

13. The motorized snowboard of claim 8, wherein the binding is configured to hold a rider's foot in a direction transverse to the longitudinal axis of the motorized snowboard.

14. The motorized snowboard of claim 8, wherein the center of gravity of the motorized snowboard has an elevation substantially equal to the binding.

15. A motorized snowboard including
a chassis including a rider-support platform positioned to support the feet of a rider and extending across the longitudinal plane of the motorized snowboard,
a motor supported by the chassis, and
an endless track positioned to contact the ground, the endless track being coupled to the chassis and powered by the motor to propel the motorized snowboard over the ground, a ground-engaging portion of the endless track having a forward portion, a mid portion, and a rear portion, the elevation of the mid portion being lower than at least one of the front and rear portions.

16. The motorized snowboard of claim 15, wherein the elevation of the mid portion is lower than the front and rear portions.

17. The motorized snowboard of claim 15, further comprising a drive sprocket coupled to the motor, an idler, and at least one bogie wheel positioned between the drive sprocket and the idler, wherein a lowermost portion of the at least one bogie wheel is positioned below the lowermost portion of the drive sprocket and the lowermost portion of the idler.

18. The motorized snowboard of claim 17, wherein the at least one bogie wheel has an outer diameter greater than the outer diameter of the drive sprocket and the outer diameter of the idler.

19. The motorized snowboard of claim 15, further comprising at least one fixed ski having a lowermost ground engaging-surface having an elevation greater than the mid portion of the ground-engaging portion of the endless track.

20. The motorized snowboard of claim 15, wherein the mid portion of the ground engaging portion of the endless track is positioned behind the longitudinal midpoint of the motorized snowboard.
